(19) United States
(12) Patent Application Publication
(10) Pub. No.: US 2016/0339276 A1
(43) Pub. Date: Nov. 24, 2016

(54) PROTECTIVE APPAREL AND SUPPORT APPARATUS AND METHOD OF USE

(71) Applicant: Medline Industries, Inc., Mundelein, IL (US)

(72) Inventors: Francis A. Czajka, Libertyville, IL (US); Troy Lother, Kenosha, WI (US); John H. Kutsch, Harvard, IL (US); Vince Lackowski, Racine, WI (US)

(21) Appl. No.: 15/225,124

(22) Filed: Aug. 1, 2016

Related U.S. Application Data
(63) Continuation of application No. 14/586,123, filed on Dec. 30, 2014, now Pat. No. 9,439,462.
Application No. 14/586,123 is a continuation of application No. 13/427,475, filed on Mar. 22, 2012, now Pat. No. 8,950,017.
(60) Provisional application No. 61/466,334, filed on Mar. 22, 2011.

(51) Int. Cl. A62B 18/08; A62B 18/04; A41D 13/12

(52) U.S. Cl. CPC A62B 18/084; A41D 13/1218; A62B 18/045

(57) ABSTRACT

A protective apparel support (100) system is disclosed comprising a support frame configured to rest on the shoulders of a wearer, the support having a first shoulder member (104a), a second shoulder member (104b) and a shield (202) engagement portion. A shield (202) is selectively coupleable to the support and protective apparel (302) is coupled to the shield.

### RELATED APPLICATIONS

This application is a continuation of U.S. application Ser. No. 14/586,123 filed Dec. 30, 2014 which claims priority to U.S. application Ser. No. 13/427,475, filed Mar. 22, 2012, which claims priority to U.S. Provisional Application No. 61/466,334 filed Mar. 22, 2011 and entitled “PROTECTIVE APPAREL AND SUPPORT APPARATUS AND METHOD OF USE,” the contents of all of which are herein incorporated by reference in their entirety.

### FIELD OF THE DISCLOSURE

The present disclosure relates generally to protective garments and garment support systems and more particularly body mounted apparatus to support protective apparel.

### BACKGROUND OF THE DISCLOSURE

Protective apparel may be worn by surgeons and other care givers or other medical personnel in order to protect patients from infection. Orthopedic procedures and particularly those involving exposed bone are very susceptible to infection and osteomyelitis. Therefore protective apparel may be used to create a sterile field, typically achieved by a gown, often referred to as a “toga” that provides a barrier between the healthcare professionals and the patient.

In some cases, helmets may be worn on the head of the surgical staff supporting the protective apparel. The helmets however can be heavy and can result in a high center of gravity as they extend upwards from the head, resulting in discomfort and an un-ergonomic fit. This can lead to undue neck and back strain on the surgeon. Further, a face shield and an apparel drape can add weight and drag to a helmet. Protective apparel including a helmet, face shield, and apparel drape often restricting movement of the wearer's head due to the added weight and drag.

Further, the face shield may result in a limited field of vision. Additionally, as a result of the contours and nature of the helmet alignment above the head, the face shield may sit close to the wearer's face and may create an uncomfortable and claustrophobic feel. Face shield size may be limited by the outer contours of the helmet. Extending portions of the face shield and/or protective apparel that hang off of the helmet may cause further drag and undue strain.

Some solutions incorporate a chin bar on the helmet that couples to portions of the apparel; however this may further limit the field of vision of the surgeon, and may add more weight to the helmet. Typically patients are positioned below the surgeon's head and may be positioned such that the chin bar obstructs the surgeon's view of the patient.

The protective apparel may enclose the wearer's head and may trap in air exhausted by the wearer. Fans have been incorporated into the helmet and positioned on top of the user's head, and may add even more weight to the helmet further exacerbating the weight and center of gravity issues described above. The fan may draw air in through the gown material and may result in increased current drain on the fan. This may result in reduced battery life or an increased size of the power source to effectively transport air into the interior space of the protective suit.

In some cases the power source must be carried off-helmet in order to incorporate enough energy to power the fan. In such case, a cable may run from the helmet to the power source, typically on a belt, and may restricting the wearer's movement, may rub against the wearer and/or may become unplugged during a procedure, such as a surgery. These fans may further prevent effective air circulation as they may merely force air into the enclosed area around the wearer's head.

Further, donning procedures may be important in maintaining the sterile field about the wearer. Current helmet systems may be cumbersome and may include unnecessary steps to don the system while maintaining sterility.

Thus, there is a need for a protective apparel support apparatus that is light weight, ergonomically configured and improves the wearer's environment.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 is a perspective view of an embodiment of a support yoke of the invention.

FIG. 2 is a side view of an embodiment of a yoke donned by a wearer of the invention.

FIG. 3 is a side view of an embodiment of a yoke donned by a wearer of the invention.

FIG. 4 is a side view of an embodiment of a yoke donned by a wearer of the invention.

FIG. 5 is a top view of an embodiment of a yoke of the invention.

FIG. 6 is a perspective view of an embodiment of a gown of the invention.

FIG. 7 is a front perspective view of an embodiment of a hood of the invention.

FIG. 8 is a rear perspective view of the hood shown in FIG. 7.

FIG. 9 is a front perspective view of an embodiment of a wearer donning the gown shown in FIG. 6 and the hood shown in FIG. 7.

FIG. 10 is a front perspective view of an embodiment of a harness of the invention.

FIG. 11 is an embodiment of a yoke attachment spring bracket of the invention.

FIG. 12 is a front perspective view of an embodiment of a wearer donning a yoke of the invention.

FIG. 13 is a side view of an embodiment of a yoke with a shield of the invention.

FIG. 14 is a front view of an embodiment of a shield of the invention.

FIG. 15 is an exploded view of an embodiment of a yoke of the invention.

FIG. 16 illustrates a first front perspective view of the protective apparel embodiment shown in FIG. 16.

FIG. 17 illustrates a first rear perspective view of an additional embodiment of a protective apparel.

FIG. 18 illustrates a first front perspective view of an additional embodiment of a protective apparel.

FIG. 19 illustrates a first rear perspective view of the protective apparel embodiment shown in FIG. 18.

### DETAILED DESCRIPTION

Before describing in detail embodiments that are in accordance with the present invention, it should be observed that the embodiments reside primarily in combinations of apparatus components and method steps for a protective apparel and support system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In describing the embodiments herein in detail and referring to the drawings, like numbers indicate like parts throughout the figures. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. While some embodiments described herein reference a user or wearer, specifically a surgeon, embodiments of a protective apparel and support apparatus can be used by any user and/or wearer, for example, surgeons and/or other doctors, scientists, students, or any other user that can use protective apparel. In this manner, while some embodiments described herein can reference a patient, in other embodiments, the wearer may be working on, for example, an experiment, a hazardous material, or any other object and/or situation that may prefer protective apparel.

Some embodiments described herein provide a protective apparel and support apparatus that provides a number of advantages, including but not limited to a more comfortable fit by offering a lower center of gravity, improved ergonomic design, a wider stance for improved field of vision, and an effective energy efficient airflow system. In such embodiment, the protective apparel and support apparatus (“apparatus”) can be supported by a user's shoulders. In such embodiments a contoured yoke support structure (“yoke”) can rest upon the upper torso of a user, for example portions of the back, shoulders and chest of a user.

In embodiments, of the invention, the yoke of the protective apparel and support apparatus can be substantially free from contact with the wearer's head. The yoke support structure can include a frame that can be shaped to fit a user's shoulders and shaped to carry and support portions of the protective apparel. The frame can carry portions of the protective apparel which may include a transparent vision shield (e.g., a face shield or shield), barrier material such as a gown, interior air replenishment devices (e.g. a fan), and can distribute the weight of the protective apparel and support apparatus about the torso of the wearer. This can provide the wearer with a comfortable, protective apparel and support apparatus that has a low center of gravity, that may not rest on the wearer's, head and that may provide an ergonomic support to improve wearability.

In some embodiments, the yoke can include a first support portion that can be configured to rest at least partially on a first shoulder of a wearer and a second support portion that can be configured to rest at least partially on a second shoulder of the wearer. Protective apparel can be coupled to the first support portion and the second support portion of the yoke support structure, and can be configured to include a vision shield in front of the wearer's face for viewing and a protective barrier over the wearer.

In some embodiments, an air circulation system can be configured to be coupled to the yoke, and can be configured to provide air replenishment and air conditioning. The air circulation system can include a first fan and a second fan. The first fan can be configured to draw air into or out of the interior of a barrier space and the second fan can be configured to draw air into or out of an interior barrier space. The first fan and the second fan can be disposed away from the wearer's ears and can reduce noise generated by the fans. The yoke can include one or more hollow chambers configured to communicate air within the yoke. In some embodiments, the first fan and the second fan can be disposed within, or coupled to a yoke support structure portion that can extend down the back of the wearer. In some embodiments, a single fan may be used to draw air out of the interior barrier space or to introduce outside air into the interior barrier space.

In some embodiments, an intake fan can be configured to direct air through a yoke portion and out of a front of the yoke in a direction substantially parallel to the wearer's vision, which in some embodiments can be toward the vision shield. This can reduce an amount of air blown directly onto the wearer's face. In such an embodiment, the air may be directed around a curvature of the vision shield in front of the wear's face and to another side of the yoke. One or more inlet ports on the other side of the yoke can be directed to an exhaust fan that can create negative pressure that can result in drawing the air out of the interior of the barrier space.

In some embodiments, the vision shield has a surface area, i.e. a field of vision, of at least 72 inches square and preferably one to four times greater than 72 inches square. A lateral distance between the first yoke portion and the second yoke portion provides for a greater field of vision as the vision shield spans from the first yoke portion to the second yoke portion while the first yoke portion and the second yoke portion are supported by the wearer's shoulders.

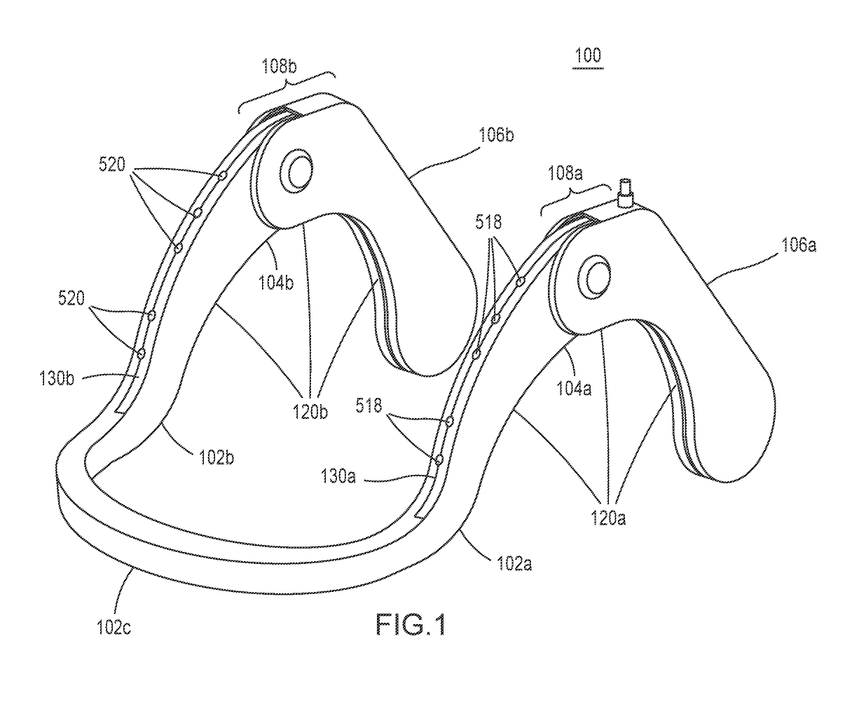

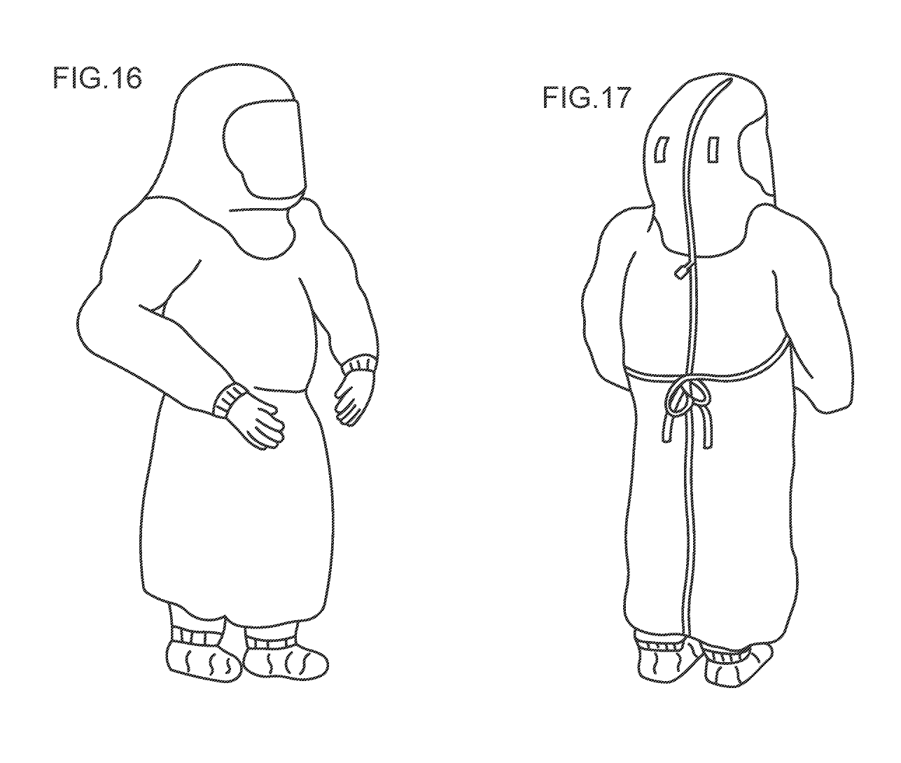

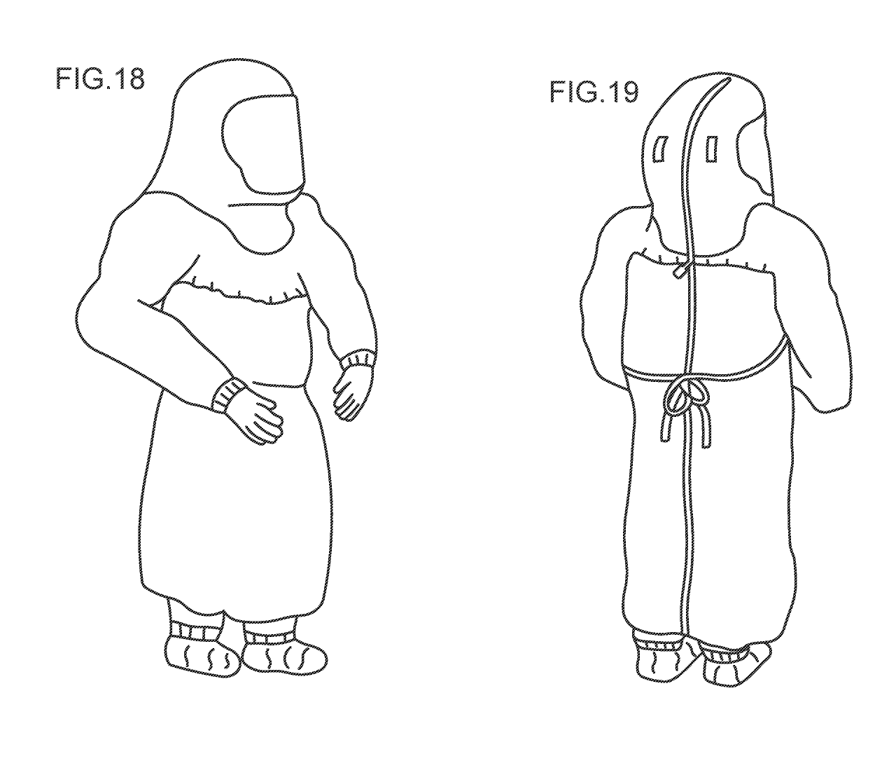

FIGS. 1-19 depict various embodiments of protective apparel and support apparatus and/or portions of apparatus. An apparatus can include a yoke, one or more gowns, togas, and/or hoods (single piece and/or multi-piece), and/or a harness, etc. While each embodiment can be described as including certain element or features, it is understood that non-mutually exclusive elements and features of any embodiment can be included in any other embodiment.

FIG. 1 depicts a yoke support structure (“yoke”) 100 of a protective apparel and support apparatus according to an embodiment. The yoke 100 is a support structure that can be configured to rest on the shoulders and upper torso region of a wearer (not shown in FIG. 1). The yoke 100 includes a first chest member 102a, a second chest member 102b and a lateral chest member 102c. The yoke 100 further includes a first back member 106a coupled to the first chest member 102a, and a second back member 106b coupled to the second chest member 102b. The yoke 100 can be configured such that the inner contours 120a, b of the yoke 100 can substantially rest on the shoulders of the wearer and can substantially rest adjacent to portions of the chest and back of the wearer. The yoke 100 can be configured to rest securely on the upper torso of the wearer and can be configured to support portions of the protective apparel (not shown). The first chest member 102a and the first back member 106a form the first shoulder portion 104a. The second chest member 102b and the second back member 106b form the second shoulder portion 104b.

In this embodiment the first back member 106a is hingedly coupled to the first chest member 102a with a first hinge 108a; and the second back member 106b is hingedly coupled to the second chest member 102b with a second hinge 108b. The first hinge 108a and the second hinge 108b can allow the yoke 100 to adjust to the size of the wearer by pivoting the chest member and the back member relative to one another about hinges 108a, 108b, to change the shoulder opening size of yoke 100. This can accommodate difference in torso thickness from one wearer to another wearer while still allowing the yoke 100 to wrap over the shoulders. In alternative embodiments, the yoke 100 is a unitary structure and may be flexible such that yoke material bends, and can allow the yoke to be “form-fit” to the wearer by bending the unitary structure. Other embodiments may incorporate a plurality of members, while some or all may be flexible or some or all may be at least semi-rigid, or a combination thereof. For example, a portion of the yoke may be a formable wire frame and another portion may be a plastic support portion.

The yoke 100 can be configured to rest on the wearer's shoulder at the first shoulder portion 104a and at the second shoulder portion 104b. In this embodiment the chest members 102a, 102b connect across the chest of the wearer with the lateral chest member 102c. In other the chest members 102a, 102b can rest on the chest without interconnecting the first and second chest members 102a, 102b. The yoke 100 can also partially rest on the chest in varying degrees with the chest members 102a-c.

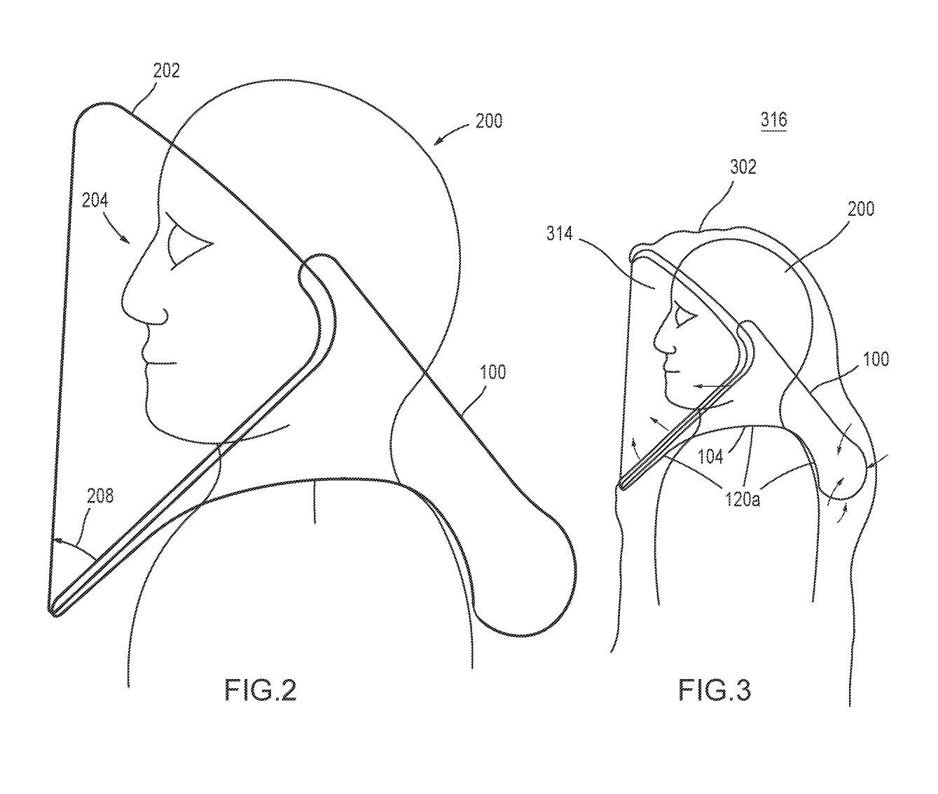

FIG. 2 is a side view of a yoke 100 shown positioned on a wearer 200. The yoke 100 is positioned on the wearer 200's shoulders and include a substantially transparent vision shield 202 positioned in front of the wearer 200's face 204. The vision shield 202 can be configured to maintain barrier protection of the protective apparel while allowing the wearer 200 to see the patient. The weight of the vision shield 202 can be supported by the yoke 100 and can be distributed onto the shoulders 206 and can transfer the weight of the vision shield 202 to the wearer. The vision shield 202 position relative to the wearer's face 204 can be a function of a standoff distance (not shown) of the vision shield 202 from the chest members 102a-c and an angle 208 of a tilt away from the yoke 100 and the wearer. Having the vision shield 202 coupled to the yoke 100 can offset the vision shield 202 a distance from the wearer's face.

The first back member 106a and the second back member 106b can act as counter weight configured to counteract a moment of force on the front of the yoke 100 due to the weight of the vision shield 202, a protective garment 302 (see, e.g., FIG. 3), and the front portion of the yoke 100. Balancing the yoke 100 minimizes movement of the yoke 100 relative to the wearer 200. A length and a weight of the back members 106a, 106b in conjunction with a weight of one or more batteries (not shown) and an air circulation system (not shown) can be configured to counter balance the moment of force on the front chest member 102a-c. While some of the force on the front of the yoke 100 can be imparted from the chest member's 102a-c on to the wearer's chest, the counter weight effect of the back members 106a, 106b can counter act the amount of force on the wearer's chest and can distribute the weight about the wearer's shoulders. The yoke 100 can cradle the wearer's torso to minimize movement of the yoke 100 as it is worn.

As shown in FIGS. 1-4, the yoke 100 can include a downward u-shape that can lower the center of gravity of the overall protective apparel and support apparatus (not shown) as it sits over the shoulders of the wearer, distributing the weight to stabilize the apparatus. Although it is preferred that movement of the protective apparel and support apparatus is minimized, some movement of the apparatus relative to the wearer may be acceptable. In such embodiments, the vision shield 202 can be sized such that some movement does not hinder the wearer's line of sight.

FIG. 3 is a side view of the yoke 100 shown positioned on a wearer 200 and includes the vision shield 202 and a protective garment 302. The protective garment 302 can be coupled to the yoke 100, the vision shield 202 and/or a combination thereof. In this embodiment the protective garment 302 is coupled to the vision shield 202. The vision shield 202 can be selectively coupled to the yoke and can be coupled to the yoke after the yoke is fitted on the wearer. In other embodiments, the vision shield 202 can be coupled to the yoke prior to the yoke being fitted to the wearer. The protective garment 302 can be, for example, a hood, a body toga, a gown, an upper torso gown, combinations of said protective garments, and/or the like. The protective garment 302 is positioned between the patient and the surgeon or care giver. The protective garment 302 and the vision shield 202 can be configured to form an interior barrier space 314. The interior barrier space 314 is generally the space between the protective garment 302 and the wearer. The wearer's head and at least portions of the upper body of the wearer are contained within the interior barrier space 314. The interior barrier space 314 is separated from an exterior 316 of the system.

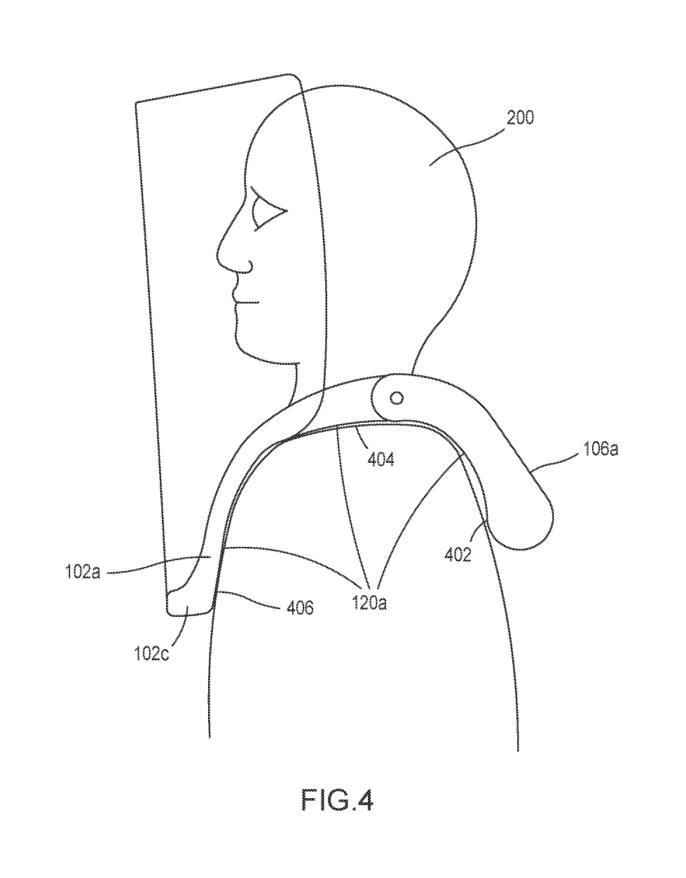

FIG. 4 is a side view of the yoke 100 as it rests on the wearer's torso, showing the conforming fit of the yoke 100 to the wearer's upper torso according to another embodiment. The back members 106a-b rest on a back portion 402 of the wearer's torso, the shoulder portions 104a-b, rest at least on the top of the wearer's shoulders and the chest members 102a-c rest on a front portion of the wearer's shoulders and the chest of the wearer's torso. The first hinge 108a can be configured to couple the first back member 106a and first chest member 102a and can allow rotation of the first back member 106a relative to the first chest member 102a and can change the shape of the yoke 100 (the distance between the first chest member 102a and the first back member 106a) to conform more closely to the wearer's torso size and shape.

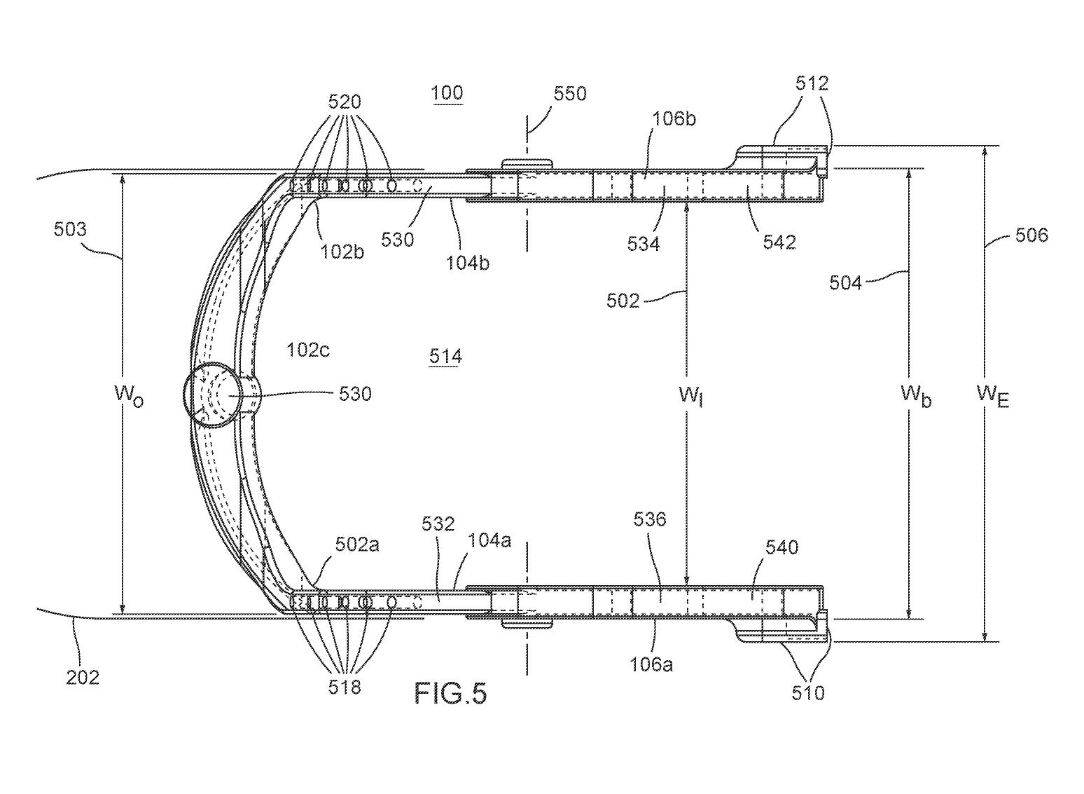

FIG. 5 is a top view of a yoke 100. In this embodiment the chest members 102a-c and the back members 106a-b have internal chambers, a first chest member chamber 530, a second chest member chamber 532, a first back member chamber 534 and a second back member chamber 536 (“chambers 532-536”). FIG. 5 further illustrates dimensions of the yoke 100.

The overall width of the yoke 100 can provide a support that is generally wider than the wearer's head which can allow for donning of the yoke 100 and the accompanying protective apparel (not shown). A first inside dimension of the yoke W_{I}, 502 measured at the rear of the yoke between the first back member 106a and the second back member 106b can be greater than 7.0 inches and preferably can be greater than 9.0 inches. A first outside dimension Wₒ, 503 measured at the outer most dimension of the front portion of the yoke 100 between an outside of the first chest member 102a and an outside of the second chest member 102b. The first outside dimension Wₒ can affect the distance the vision shield 202 is positioned relative to the wearer once the yoke 100 is donned. The wider the yoke 100 (Wₒ), the wider the vision shield 202 and subsequently, the greater the field of vision, as well as the greater the distance the shield 202 will be offset from the wearer's face.

Yoke 100, as shown in FIG. 5, further includes air transport ports, specifically, a first air port 510 and a second air port 512. The first air port 510 and the second air port 512 are configured to allow air to be communicated between the interior barrier space 514 (or similarly as interior barrier space 314) of the system to the outside of the barrier. In this manner, air within the interior barrier space 514 can be replenished. In some embodiments one or more fans can be used for air circulation and/or replenishment. In this embodiment, a first fan 540 (shown in broken line) draws air into the interior barrier space 514 through the first external air port 510 while a second fan 542 (shown in broken line) exhausts air from the interior barrier space 514 through the second air port 512. The air that enters through the first air port 510 is communicated through the chambers 532-536 and then introduced to the interior barrier space 514 by at least one inlet ports 518. After flowing through the interior barrier space 514, the air that enters the yoke 100 through one or more outlets 520, travels through the one or more other of chambers 532-536 and is exhausted from the yoke 100 by the second blower fan 542 through the second external port 512.

The inlet port 518 may be formed in any of the chest members 102a, 102b, 102c. As shown in FIG. 5, yoke 100 includes more than one inlet port 518; specifically, first chest member 102a can include a set of inlet ports 518, and second chest member 102b can include a set of outlet ports 520. While shown in FIG. 5 as including a certain shape and/or location, in some embodiments, the shape and/or location of the one or more inlet and outlet ports can vary. For example the one or more ports may be one or more slots in the yoke 100.

In this embodiment the inlet ports 518 can introduce air into the interior barrier space 514 from first air port 510, while the outlet ports 520 can remove air that can be exhausted from the second air port 512. This is in effect a push/pull system wherein air is introduced (pushed) into the interior barrier space 514 by the first air port 510, a first fan (shown later) and the inlet ports 518 and exhausted (pulled) through the second set if internal ports 520, a second fan (shown later) and the second external port 512. In this embodiment the air may be directed from the inlet ports 518 toward the vision shield 202 and drawn across the shield into the outlet ports 520, thereby replenishing the air in the interior barrier space 514. It is also understood by those of ordinary skill in the art that ports may be placed throughout the yoke. The ports may also be directed at the wearer or directed away from the wearer. Alternatively, various ports may be directed in different directions.

As described herein, a protective apparel and support apparatus can define an interior barrier space and a sterile field to substantially separate a wearer, for example a surgeon, from a person or thing, for example a patient. In some embodiments the apparatus includes a one-piece suit that covers the head and the body portions of the wearer. In some embodiments, the apparatus includes multi-piece suits, for example, having a hood portion to cover a wearer's head and/or upper body, and a gown portion to cover a wearer's upper body and lower body. In these embodiments the yoke 100 is placed on the wearer and at least under the head covering portion of the protective apparel. In other embodiments the yoke 100 rests on the wearer under all portions of the protective apparel.

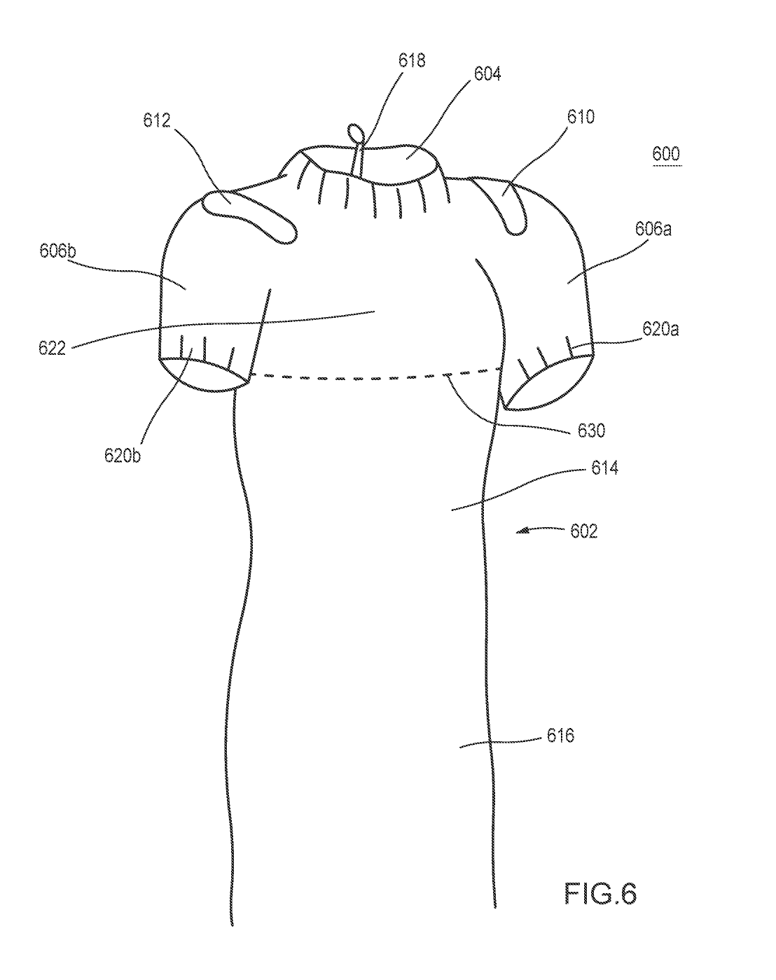

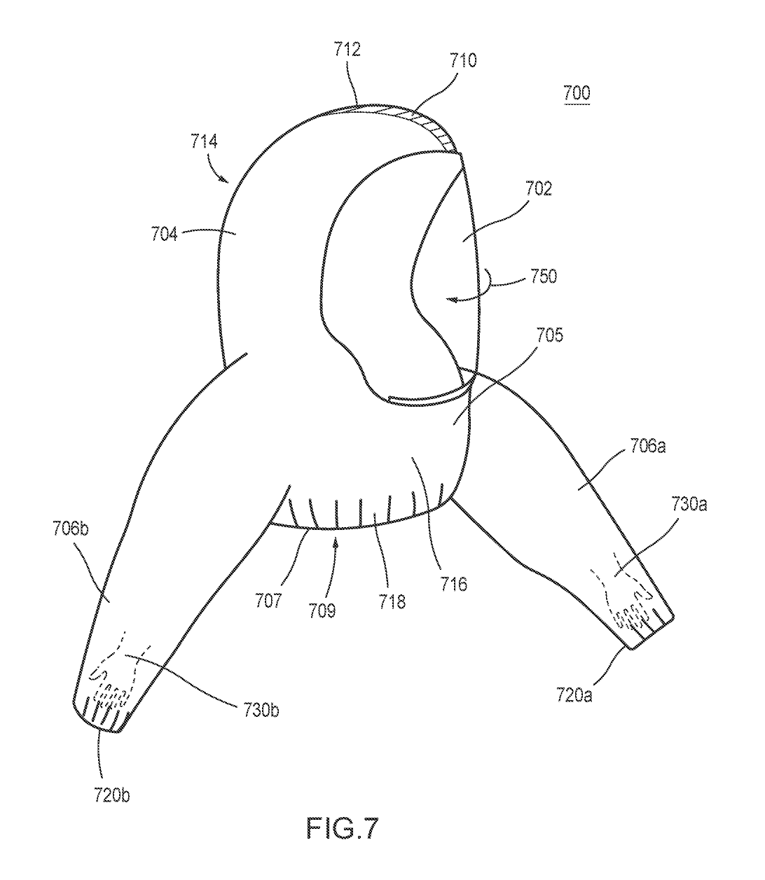

FIG. 6 is a perspective view of a protective gown 600 that may form a portion of the invention. The protective gown 600 can include a front 602 and a back (not shown), a neck opening 604, a first sleeve 606a and a second sleeve 606b. The protective gown 600 has a chest portion 622, which can be indicated as the portion above the dash line 630. The protective gown 600 includes a first yoke receiving area 610 and a second yoke receiving area 612. The protective gown 600 also includes an abdominal portion 614 and a bottom portion 616. The protective gown may also include a zipper 618. While shown in FIG. 6 as including a zipper 618, in other embodiments, protective gown 600 can include other fastening devices, such as hook and loop fasteners, adhesive or the like when the protective gown 600 is configured to fully encloses the back of the wearer. While the sleeves 606a, 606b are depicted in FIG. 6 as being short sleeves, in other embodiments, sleeves 606a, 606b can be long sleeves or, in some embodiments, the gown may not have sleeves at all so long as other protective garment portions provide complimentary protection. In such embodiments, the apparatus can include a second gown portion including sleeves (see, e.g., FIG. 7). Each sleeve 606a, b may have an elastic cuff 620a, b. The protective gown 600 can be used with a second protective portion (see, e.g., FIG. 7), which may be a hood.

FIG. 7 is a perspective view of a second protective gown portion, specifically, a hood 700. Hood 700 includes a vision shield 702, a head portion 704, a body portion 705 which includes a chest area 716, and a pair of sleeves 706a, b. Hood 700 may include a zipper 710 running from the front of the hood to the back over a top 712 of the hood 700 and down a back 714 of the hood 700. Hood 700 can include one or more elastic elements. Specifically, hood 700 includes a chest elastic 718 included around the chest area 716 and can include elastic sleeve cuffs 720a, b at least at the end of sleeves 706a, b. The first sleeve 706a and the second sleeve 706b are configured as long sleeves in this embodiment. The chest area 716 has a bottom edge 707 which defines a chest opening 709. While shown in FIG. 7 as including long sleeves, in other embodiments, hood 700 can include no sleeves or short sleeves. In such embodiments, hood 700 can be included in an apparatus having a first gown that includes long sleeves. In this manner, at least one of either the first gown or the hood can includes long sleeves.

The hood 700 can include the same material as the protective gown 600 or it can include different material. For example the hood 700 may be made of a more breathable material than the protective gown 600. The hood 700 may be made of a lighter material than the protective gown 600. In other embodiments, the hood 700 has a different barrier protection level than the protective gown 600, for example, the hood 700 material may have a protection level in accordance with the Association for the Advancement of Medical Instrumentation (AAMI) standards. The material may be different from gown to gown or even within a single gown, the protective gown 600 may be rated at different AAMI standard levels. Different portions of each the hood 700 and the protective gown 600 may have different materials or protection levels as well. In some embodiments, one or both of the protective gown 600 and/or the hood 700 can include woven, non-woven materials, plastics or the like. In some embodiments, materials may be biodegradable, compostable or both.

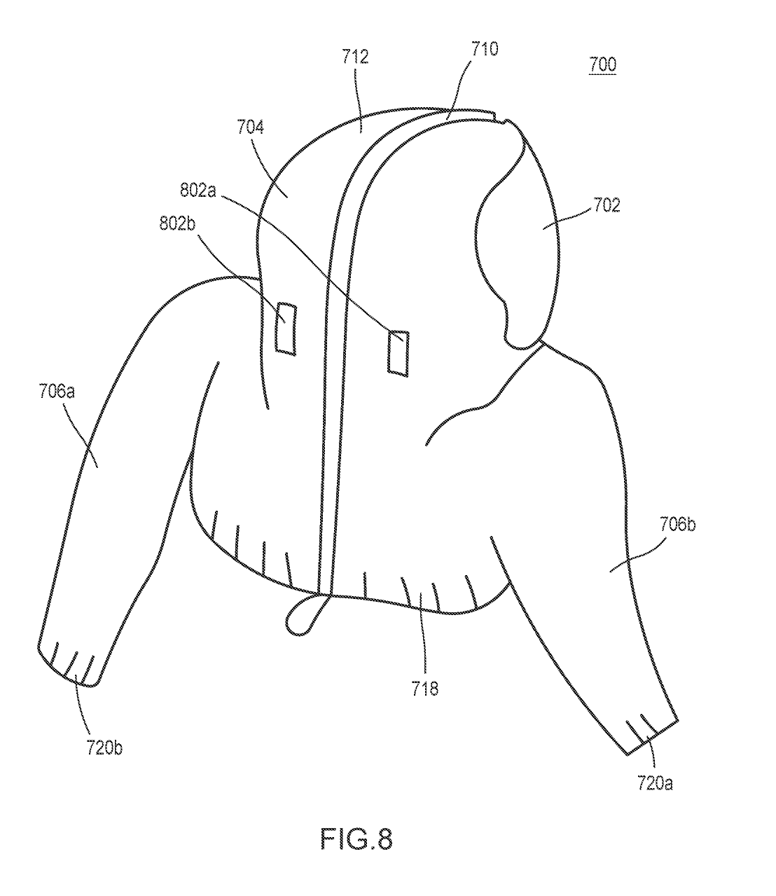

FIG. 8 is a rear perspective view of the hood 700. The hood 700 further includes a first hood port 802a which is a void in the hood 700. The hood port 802a is configured to substantially align with and be coupled to an air port of a yoke, for example, the first air port 510 of the yoke 100. The hood portion further includes a second hood port 802b which is a void in the hood 700. The hood port 802b is configured to substantially align and is configured to be coupled to an air port of a yoke, for example, the second air port 512 of the yoke 100. The hood ports 802a, 802b are formed by voids in the hood material to allow for the flow of air between the interior barrier space and an exterior space. In some embodiments, the flow of air can be induced by the at least one fan of the yoke 100. In some embodiments, one or both of port 802a, 802b can include a porous covering, for example, a mesh and/or a filter.

As described above, the hood ports 802a, 802b can be configured to be coupled to a first air port and/or a second air port of a yoke, for example the first air port 510 and the second air port 512 of the yoke 100. In such embodiments, the air ports of the yoke can be configured to be secured to the hood ports 802a, 802b using hook and loop fasteners or another fastening system. In such embodiments, securing the air ports of the yoke to the hood ports 802a, 802b can maintain the alignment of the air ports with the hood ports. In another embodiment, the hood port 802a may have a size smaller than an outside dimension of the first air port 802a of the yoke 100. In this embodiment the hood port 510 is sized large enough to slip over the first air port 510 and may be held in place by a detent (not shown) in the first air port 510. In yet another embodiment, the hood port 802a is greater in size relative to the first air port 510 of the yoke 100 such that the hood port generally aligns with the first port 510 when the hood is donned.

In an apparatus including the hood 700 and the first gown portion 600, the hood 700 can be donned such that portions of the gown 600 are covered by the hood 700 to complete the sterile field about the wearer. In such embodiments, the sleeves 606a, b of the protective gown 600 are overlapped by the sleeves 706a, b of the hood 700. The overlap can be configured to maintain the sterile filed. The chest elastic 718 of the hood 700 holds the chest area 716 of the hood 700 tight to the chest portion 622 of the protective gown 600 such that the there is sufficient material overlap to maintain the sterile field. While the hood 700 is shown as including a certain body portion 705 hood 700 length, in other embodiments, the length of the body portion can be shorter, or longer, for example, extending below the chest area for example.

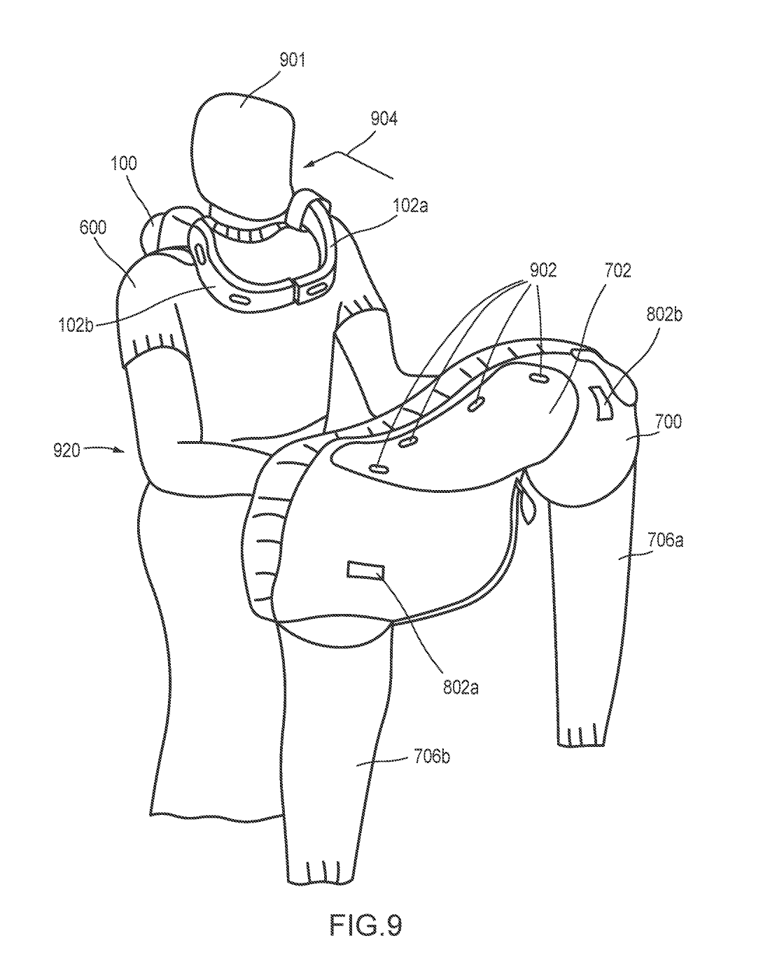

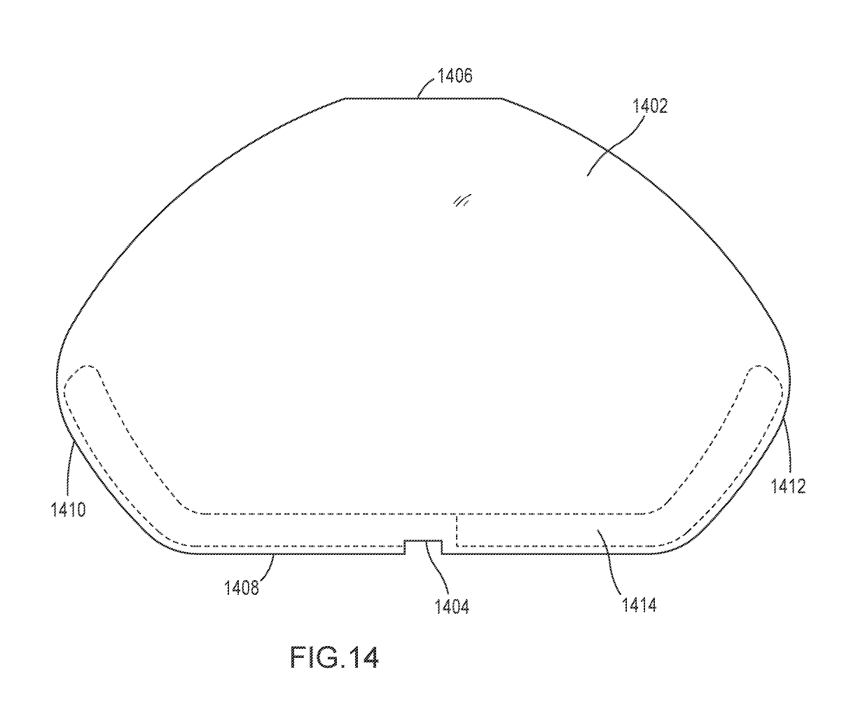

FIG. 9 illustrates a wearer 901 of an apparatus including the protective gown 600, the yoke 100, and the hood 700. Specifically, FIG. 9 illustrates the wearer 901 with the protective gown 600 on and the yoke 100 placed on the wearer over portions of the protective gown 600, with the hood portion off. The back members 106a, b of the yoke 100 are not connected so as to accommodate rear entry donning of the yoke 100 by the wearer 901. The wearer 901 slides the yoke 100, indicated by arrow 902, on from a front side of the wearer 901 and then down onto the shoulders of the wearer 901. The wearer 901, in this illustration, is holding the hood 700 in preparation to don the hood 700 over the yoke 100 and over the gown 600. The hood 700 is shown here in an open position to be donned on the wearer 901 such that sterile filed is maintained. The hood 700 is then closed, by zipping up the hood 700 in this embodiment. The shield 702 has a yoke receiving element 1404 (see e.g., element 1404 in FIG. 14) that includes notches or voids in the shield, adhesive, hook and loop or other securement devices, or a combination thereof. Hook and loop fasteners 902 may be placed at various positions on the shield 702 and the yoke 100 to hold the shield to the yoke 100.

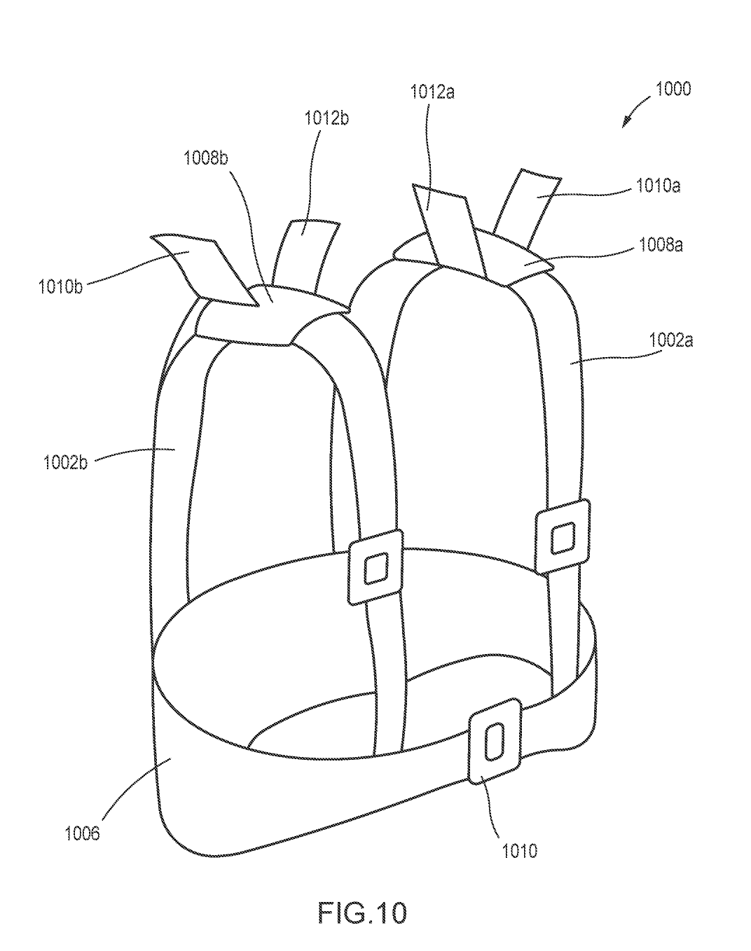

FIG. 10 illustrates a harness 1000 configured to be coupled to the yoke 100. Although the configuration of the yoke 100 can allow it to be a stand alone apparatus, the harness 1000 can supplement the yoke 100 as part of the apparatus. In some situations, the harness 1000 may provide improved fit for the wearer. In other embodiments the harness 1000 provides additional ergonomic features. The harness 1000 includes shoulder straps, specifically a first shoulder strap 1002a, a second shoulder strap 1002b, and a belt 1006. The first shoulder strap 1002a includes a first yoke attachment portion 1008a and the second shoulder strap 1002b includes a second yoke attachment portion 1008b. The harness 1000 may be used in conjunction with the yoke 100 and a protective garment as part of a protective apparel and support apparatus. In this embodiment, the belt portion 1006 of the harness 1000 can be configured to provide support for the lower back and abdominal regions of the wearer.

In this embodiment, the yoke attachment portions 1008a, b comprise a pair of attachable straps that comprise a first yoke securement strap 1010a, b and a second yoke securement strap 1012a, b for each shoulder strap 1002a, b. The first yoke securement strap 1010a and a second yoke securement strap 1012a are configured to be selectively coupled to a first side of the yoke 100 and a first yoke securement strap 1010b and a second yoke securement strap 1012b are configured to be selectively coupled to a second side of the yoke 100.

In this embodiment, the harness 1000 is worn by the wearer and the yoke 100 is placed on to the wearer. The yoke can rest adjacent to at least a portion of the yoke attachment portions 1008a-b of the harness 1000. The first yoke securement strap 1010a and a second yoke securement strap 1012a can be wrapped over the yoke 100 and coupled together by a fastener, which in this embodiment is a hook and loop fastener. At least one of the first and second yoke securement straps 1010a, 1012a are elastic and can be stretched over the yoke 100 to secure the yoke to the harness 1000. The same applies to the first yoke securement strap 1010b and a second yoke securement strap 1012b coupling the second side of the yoke 100 to the harness 1000. Once the harness 1000 is coupled to the yoke 100, the protective apparel may be fitted to the yoke and the wearer.

Other embodiments and means for coupling the yoke to the harness will be evident to those of ordinary skill in the art. Some embodiments include providing hook and loop fastener on conjoining portions of the yoke and the harness. In this embodiment a first portion of the hook and loop fastener resides on the top of the shoulder strap and aligns with a second complimentary hook and loop fastener portion attached to the underside of the yoke, selectively coupling together when the yoke is placed on the harness 1000.

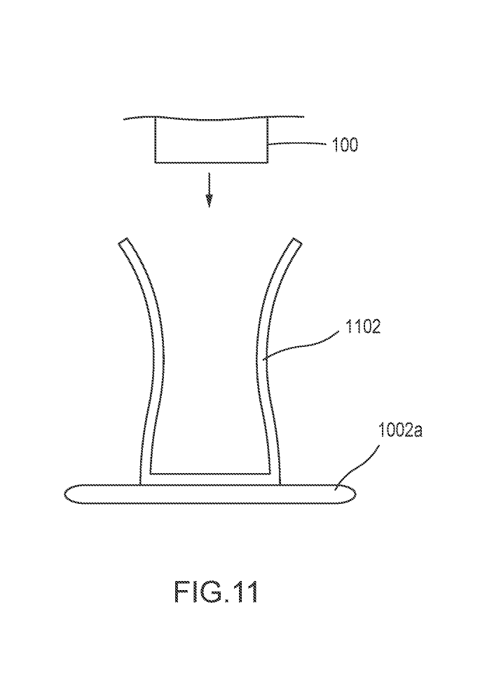

In yet another embodiment, the yoke attachment portion is a spring bracket coupled to the shoulder strap of the harness 1000, illustrated in FIG. 11. The spring bracket 1102 is a u-shaped bracket that receives the yoke 100, holding the yoke 100 to the harness 1000 through the frictional forces of the spring. An additionally securement strap may be placed at the top of the u-shape bracket 1102 in some embodiments.

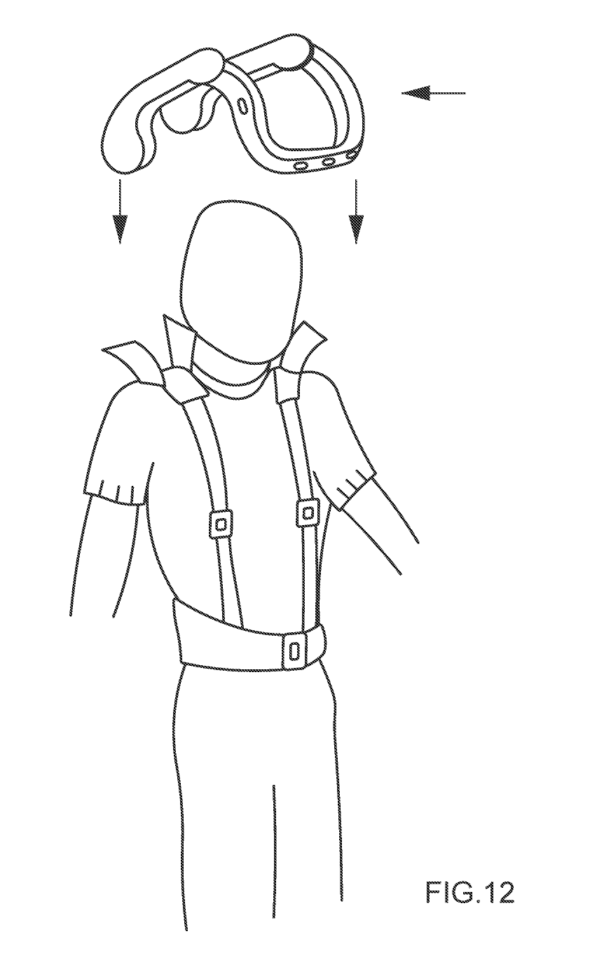

FIG. 12 is a perspective view of a harness 1000 that is being coupled to the yoke 100 as it is donned on the wearer. Once the yoke 100 is in place, the yoke securement straps can be wrapped over the yoke portions and secured together.

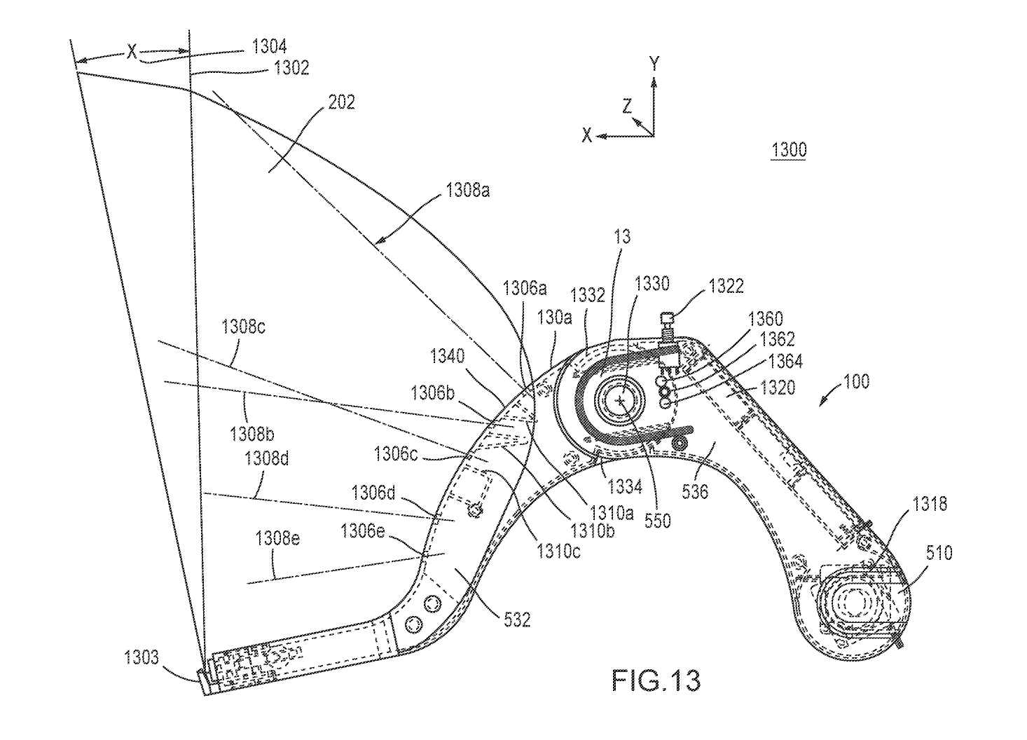

FIG. 13 is a side view 1300 of the yoke 100 with the vision shield 202 coupled thereto. The air flow directions and internal portions of the yoke are represented in broken line format. Inlet ports 518 (see, e.g. FIG. 5) are shown as a first internal air port 1306a, a second internal air port 1306b, a third internal air port 1306c, a fourth internal air port 1306d, and a fifth internal air port 1306e. The internal air ports are configured to communicate with the internal chambers 530, 532, 534 and 536. Some of the internal air ports can be associated with one or more air baffles. In this embodiment the air baffles are located within the yoke 100. The air ports 1306 a-e may be apertures in the yoke 100 or the apertures may be complimented by nozzles or the like.

The first internal air port 1306a is shown as an aperture in the yoke 100 chest member 102a. A first airflow line 1308a indicates the general direction of flow of air as it discharges from the first internal port 1306a.

The second internal air port 1306b is an aperture in the chest member 102a. Adjacent to the second port 1306b is a first air baffle 1310a. The first air baffle 1310a is configured to direct at least some of the air out of the internal port 1306b. The first air baffle 1310a is also configured in this embodiment to direct air into the first internal air port 1306a.

The third internal air port 1306c is an aperture in the chest member 102a. Adjacent to the third port 1306c is a second air baffle 1310b configured to divert air through the third port 1306c and in the general direction of the third airflow line 1308c. The second air baffle 1310b is also configured in this embodiment to direct air into the second internal air port 1306b.

The fourth internal air port 1306d is an aperture in the chest member 102a. Adjacent to the fourth port 1306d is a third air baffle 1310c configured to divert air through the fourth port 1306d and in the general direction of the fourth airflow line 1308d. The third air baffle 1310c is also configured in this embodiment to direct air into the third internal air port 1306c.

The fifth internal air port 1306e is an aperture in the chest member 102a. Adjacent to the fifth port 1306e is the third air baffle 1310c configured to divert air through the fifth port 1306e and in the general direction of the fourth airflow line 1308e.

In the embodiment illustrated in FIG. 13, the internal air ports 1306 a-e are located in a chest member top 130a of yoke 100. This position in the yoke 100 allows the air to be directed parallel to the wearer's line of sight and not onto the wearer directly. The air flow is directed along the vision shield 202, beginning where the vision shield 202 meets the yoke 100 at a yoke-shield interface line 1340. The air flow generally travels along the shield 202 until the shield curves around to mate with the second chest member 102b. Said another way, the shield can include a curvilinear shape; can extend from a first side of yoke 100 to a second side of yoke 100; and can curve around a chest portion 102a-c. The air can be diverted by the vision shield 202 and can generally travel around the shield 202 and can be directed toward the opposite side of the vision shield 202 and the second chest member 102b. In this embodiment, the air can travel from one of internal air ports 1306 a-e on a first side of the yoke 100 to an internal air port (not shown) on a second side of the yoke 100.

The quantity of internal air ports may be fewer than or greater than those illustrated in the present embodiment. The size of the apertures may also vary, and may further vary from port to port. The air can flow to the internal air ports 1306 a-e via one or more internal chambers, or internal chamber portions of the yoke 100. The internal chamber comprises the first chamber 532 of the chest member 102a which is in communication with the second chamber 536 of the back member 106a of the yoke 100. The hinge portion 1330 of the chest member 102a and the back member 106a, is configured to couple the chest member 102a and the back member 106 a such that the air can move between the chest member 102a and the back member 106, and the internal air ports and external air ports. As shown in FIG. 13, yoke 100 can include a blower (e.g. a fan) 1318. Blower 1318 can be disposed within the back member 106a and can be adjacent to the external air port 510. In this embodiment the blower 1318 can draw air into the yoke chamber, the second chamber 536, which then travels through the hinge 1330 to the first chamber 532 and out the internal air ports 1306a-e.

In this embodiment outlet ports 520 (see FIG. 5) have a similar arrangement, as with the first chest member 102a of the yoke portions illustrated in FIG. 13, in the second chest member 102b. A second blower can be disposed in the back member 106b however; the second blower can be configured to draw air out of the interior barrier space 514 through outlet ports 520, a first and second chamber of the second chest member 102b, through the second blower and out the second external port 512.

Also illustrated in FIG. 13 is the configuration of the vision shield 202 relative to the yoke 100. The vision shield 202 may be angled away from the vertical axis 1302 at a shield angle 1304, which may be an angle between 0 degrees and at least 45 degrees. In this embodiment the shield angle 1302 is between 20 and 30 degrees and may preferably be about 25 degrees from the vertical ‘Y” axis 1302. This angle 1304 in conjunction with the configuration of the yoke 100 can offset the vision shield 202 surface from the wearer's face making the system more comfortable for the wearer. The yoke 100 extends in the X direction away from the users face, while the vision shield 202 further extends away from the face by nature of the angle, both creating the distance between the wearer's face and the shield 202 while distributing the weight of the shield 202 and garment 302 to the upper torso. Further, the shield 202 may support portions of the protective apparel that extend beyond the wearer's head, and can hold the apparel out of the wearer's face.

As shown in FIG. 13, yoke 100 can include a power system for the blower 1318 including one or more batteries 1320 and a switch 1322 coupled between the batteries 1320 and the blower 1318. The batteries 1320 and the blower 1318 can be positioned within the yoke 100 to provide counter weight to the shield 202 and the protective apparel, balancing the yoke on the wearer. The blower 1318 can be a Sunon GB0545AFV1-8 with maglev bearing for example. Those of ordinary skill in the art will understand that other fans or blowers may achieve the results intended in accordance with this disclosure.

FIG. 14 illustrates a shield 1402 in accordance with one embodiment of the disclosure. Shield 1402 can be similar to and can include similar elements to shield 202. In this manner, shield 1402 can be part of any protective apparel and support apparatus described herein. The shield 1402 includes a top 1406 and a bottom 1408, a first side 1410 and a second side 1412. The bottom includes a yoke engagement element 1404, which can be a void or a notch in the shield 1402 as illustrated in this embodiment. This engagement element may mate with a shield receiving element (see 1303 in FIG. 13). The first side 1410 and the second side 1412 can include portions configured to couple to the yoke 100 with securement devices such as fasteners. The fasteners may include, and are not limited to those that would secure the shield to the yoke, such as hook and loop fasteners, adhesive, buttons, snaps, keyholes, clips an the like. The shield is substantially clear and may have coating such as anti-glare, anti-reflection, hydrophobic, anti-fog and the like. The securement devise may be placed on or incorporated into the shield in the fastener area 1414.

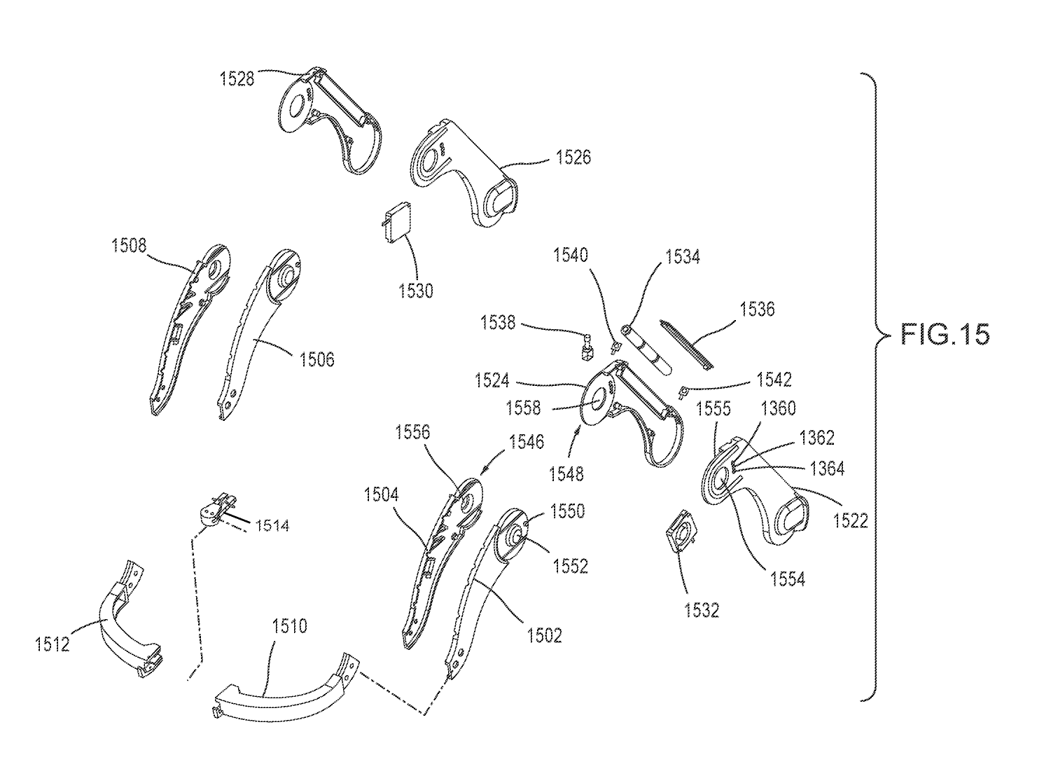

FIG. 15 is an exploded perspective view of the components of the yoke 100. The yoke 100 in this embodiment comprises a first chest member first half 1502 and first chest member second half 1504, a second chest member first half 1506 a second chest member second half 1508, a third chest member first half 1510 and a third chest member second half 1512. In this embodiment the third chest member first half 1510 and the third chest member second half 1512 are coupled together by a hinge 1514. The hinge may further include an adjustment device, for example a threaded adjustment device configured to adjust the angle of the hinge and hence the angle of the third chest member first half 1510 and the third chest member second half 1512.

The first chest member first half 1502 and first chest member second half 1504 are coupled together to form the first chest member 102a. The second chest member first half 1506 and a second chest member second half 1508 are coupled together to form the second chest member 102b. The first chest member 102a and the second chest member 102b have an internal chamber enclosed on four sides creating a hollow internal air flow chamber. The third chest member 102c includes two single piece portions 1510, 1512, which may have a chamber or may be open ended on at least one side. The halves may be secured together by screws, adhesive or other sufficient securement means as known to those of ordinary skill in the art.

The yoke 100 in this embodiment includes a first back member first half 1522 and first back member second half 1524, a second back member first half 1526 and a second back member second half 1528. A first back member first half 1522 and first back member second half 1524 are coupled together to form the first back member 106a. The second back portion first half 1526 and a second back member second half 1528 are coupled together to form the second back member 106b. The first back member 106a and the second back member 106b have an internal chamber enclosed on four sides creating a hollow internal air flow chamber.

The first chest member 102a and the first back member 106a are coupled together by hinge 108a as shown in FIG. 1, and similarly in FIG. 13 and in exploded view in FIG. 15. The first chest member first half 1502 and the first chest member second half 1504 are assembled to form the first chest member 102a with the first chest member hinge at a first end 1546 of the first chest member 102a. The first back member 106a, comprising the first back member first half 1522 and the first back member second half 1524 are assembled such that the back member hinge engages with the chest member hinge. In this embodiment the chest member hinge is partially contained within the back member hinge, e.g. in a fork like manner.

The first chest member hinge 1332 includes a first protrusion 1550 and a second protrusion 1552. The second protrusion 1552 selectively engages with a first void 1554 in the first back member hinge 1555. The second protrusion 1552 and the first void 1554 share a common axis about which is an axis of rotation 550 (see FIG. 13) for the first chest member 102a and the first back member 106a.

The second protrusion 1550 can engage one of the plurality of voids, specifically, a second void, a third void and a fourth void in this embodiment. The second protrusion 1550 in combination with one of the second void 1360 third void 1362 or fourth void 1364, can secure the first chest portion 102a at a first, second, or third angel relative to the back member 106a. The second protrusion 1550 is configured on the first end 1546 which may be flexible such that the protrusion may flex inwards and disengage the one of the second void 1360, third void 1362 or fourth void 1364. The second protrusion 1550 can include a button surface that may be accessible to a wearer's finger that is pushed on, to disengage the second protrusion from the first void 1360 of back member and allow the back member 106a to rotate, until the second protrusion 1550 engages another one of the voids e.g. the third void 1362 or the fourth void 1364 of the back member hinge portion.

As shown in FIG. 15, the yoke may include a power system for a first fan 1532 and a second fan 1530. The power system may include one or more batteries 1534, one or more battery contacts 1540, 1542, a battery compartment cover 1536, and a battery switch 1538.

While the present disclosure and what the best modes of the inventions have been described in a manner establishing possession hereof by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims. For example, while references have been made to specific dimensions, in other embodiments the dimensions can be different. For example, protective apparel and support apparatus described herein can be manufactured in sizes, e.g., small, medium, large, one size fits all, etc.

What is claimed is:

1. A protective apparel and support apparatus, comprising:
a first gown portion defining a first barrier;
a second gown portion including a vision shield defining a second barrier;
a yoke configured to rest on the shoulders of a wearer, the yoke comprising:
a front portion and a rear portion;
a cavity;
a chamber to communicate air within the yoke;
an inlet air port that receives air directed from outside of the barrier space defined by the shield;
an outlet air port that receives air directed from inside of the barrier space defined at least in part by the vision shield;
an air circulation system comprising a blower; and
a power supply;
wherein the vision shield is attached to the yoke front portion.

2. The apparatus of claim 1, wherein the yoke front portion supports the vision shield.

3. The apparatus of claim 1, wherein the power supply is positioned within the cavity and provides counter weight to the vision shield.

4. The apparatus of claim 1, wherein the blower is in fluid communication with the chamber.

5. The apparatus of claim 1, wherein the blower directs air out of an interior barrier space.

6. The apparatus of claim 1, wherein the blower introduces air into an interior barrier space.

7. The apparatus of claim 1, wherein the blower is a first blower and the air circulation system further comprises a second blower, wherein the first blower directs air out of an interior barrier space and the second blower introduces air into an interior barrier space.

8. The apparatus of claim 1, wherein the blower is positioned within the yoke rear portion and provides counter weight to the vision shield.

9. The apparatus of claim 1, wherein the yoke rear portion has a first end adjacent to the wearer's ear and a second end spaced apart from the wearer's ear and the blower is disposed adjacent to the second end.

10. The apparatus of claim 1, wherein the outlet air port is positioned on the yoke front portion and directs an airflow substantially parallel to a wear's vision.

11. The apparatus of claim 10, wherein the outlet airflow is directed toward the vision shield.

12. The apparatus of claim 1 further comprising a securement device for supporting the yoke.

13. The apparatus of claim 1, wherein the yoke comprises unitary structure.

14. The apparatus of claim 13, wherein the unitary structure is flexible.

15. The apparatus of claim 13, wherein the unitary structure is at least semi-rigid.

16. The apparatus of claim 13, wherein the unitary structure comprises a wire frame and a synthetic plastic support portion.

17. A protective apparel and support apparatus, comprising:
a first gown portion defining a first barrier;
a second gown portion including a vision shield defining a second barrier;
a yoke configured to rest on the shoulders of a wearer, the yoke comprising:
a unitary structure that is flexible in part and semi-rigid in part;
a front portion supporting the vision shield;
a cavity;
an air circulation system comprising a blower;
a power supply; and
an air chamber in fluid communication with the blower.

18. The apparatus of claim 17, wherein the cavity is a first cavity, the yoke further comprises a second cavity, the power supply is positioned within the first cavity, and the blower is positioned within the second cavity.

19. The apparatus of claim 17, wherein the yoke further comprises a rear portion, the cavity is formed in the rear portion, and the power supply is positioned within the cavity and provides counter weight to the shield.

20. The apparatus of claim 17, wherein the blower is positioned within the cavity and provides counter weight to the shield.
